(19) United States
(12) Patent Application Publication
(10) Pub. No.: US 2012/0209653 A1
(43) Pub. Date: Aug. 16, 2012

(54) GAS PIPELINE NETWORK CONFIGURATION SYSTEM

(75) Inventors: Kavitha Andoji, Hyderabad (IN); Swetha Prasanna Mukkavilly, Hyderabad (IN); Sudha Reddy Rapolu, Hyderabad (IN)

(73) Assignee: GENERAL ELECTRIC COMPANY, Schenectady, NY (US)

(21) Appl. No.: 13/027,660

(22) Filed: Feb. 15, 2011

(51) Int. Cl. G06Q 10/00

(52) U.S. Cl. 705/7.26

(57) ABSTRACT

Aspects of the invention provide for a pipeline network configuration system. In one embodiment, a system is disclosed having: at least one computing device adapted to configure a pipeline network by performing actions including: obtaining fault data about components in the pipeline network, the fault data including: fault history data, fault ticket data, and historical disaster data; determining a replacement priority for at least two of the components in the pipeline network based upon the fault data; and generating a set of replacement work instructions, along with a geographical information system (GIS) visualization, for the at least two components based upon the replacement priority.

### BACKGROUND OF THE INVENTION

The disclosure relates generally to a configuration system for a pipeline network. More particularly, the disclosure relates to a configuration system for a pipeline network (e.g., a gas pipeline network) that uses geographical information system (GIS) representations to plan portions of a pipeline network.

Formation of gas utility networks, such as gas pipeline networks, conventionally includes three general phases: construction, energizing and maintenance. In the maintenance phase, a variety of factors may influence a utility network manager to make decisions whether to retain or replace (either partially or in bulk) components in the network. These factors may include, among others: component fault histories, component age, component material type, soil type, whether components are linked to critical customers, market forecasts, and likelihood of a natural disaster. Conventional approaches to managing gas pipeline networks fail to properly consider these factors, among others.

### BRIEF DESCRIPTION OF THE INVENTION

Aspects of the invention provide for a pipeline network configuration system. In one embodiment, a system is disclosed having: at least one computing device adapted to configure a pipeline network by performing actions including: obtaining fault data about components in the pipeline network, the fault data including: fault history data, fault ticket data, and historical disaster data; determining a replacement priority for at least two of the components in the pipeline network based upon the fault data; and generating a set of replacement work instructions for the at least two components based upon the replacement priority.

A first aspect of the invention includes a system having: at least one computing device adapted to configure a pipeline network by performing actions including: obtaining fault data about components in the pipeline network, the fault data including: fault history data, fault ticket data, and historical disaster data; determining a replacement priority for at least two of the components in the pipeline network based upon the fault data; and generating a set of replacement work instructions for the at least two components based upon the replacement priority.

A second aspect of the invention includes a program product stored on a computer readable medium, which when executed by at least one computing device, performs the following: obtains fault data about components in the pipeline network, the fault data including: fault history data, fault ticket data, and historical disaster data; determines a replacement priority for at least two of the components in the pipeline network based upon the fault data; and generates a set of replacement work instructions for the at least two components based upon the replacement priority.

A third aspect of the invention includes a system having: at least one computing device adapted to configure a pipeline network by performing actions including: obtaining fault data about components in the pipeline network, the fault data including: fault history data, fault ticket data, and historical disaster data; determining a replacement priority for at least two of the components in the pipeline network based upon the fault data; and generating a set of replacement work instructions for the at least two components based upon the replacement priority; and a user interface operably connected to the at least one computing device, the user interface for displaying the replacement work instructions.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows an environment including pipeline network configuration system according to embodiments of the invention.

FIG. 2 shows a method flow diagram illustrating a process according to embodiments of the invention.

FIG. 3 shows a method flow diagram illustrating a process according to embodiments of the invention.

FIG. 4 shows a method flow diagram illustrating a process according to embodiments of the invention.

FIG. 5 shows an example component table utilized according to embodiments of the invention.

FIG. 6 shows an example site table utilized according to embodiments of the invention.

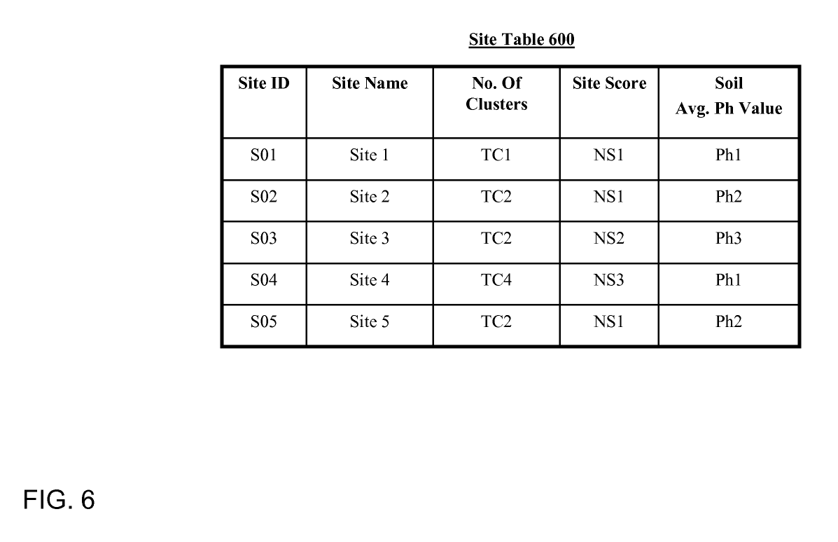

FIG. 7 shows an example color table utilized according to embodiments of the invention.

FIG. 8 shows an example cluster table utilized according to embodiments of the invention.

FIG. 9 shows an example work instruction map generated according to embodiments of the invention.

FIG. 10 depicts example scenarios of clustering and merging groups of components in a gas pipeline network according to embodiments of the invention.

FIG. 11 shows an example work instruction map generated according to embodiments of the invention.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

As indicated above, the disclosure provides a configuration system for a pipeline network. More particularly, the disclosure relates to a configuration system for a pipeline network (e.g., a gas pipeline network) that uses geographical information system (GIS) representations to plan portions of a pipeline network.

Formation of gas utility networks conventionally includes three general phases: construction, energizing and maintenance. In the maintenance phase, a variety of factors may influence a utility network manager to make decisions whether to retain or replace (either partially or in bulk) components in the network. These factors may include, among others: component fault histories, component age, component material type, soil type, whether components are linked to critical customers, market forecasts, and likelihood of a natural disaster. Conventional approaches to managing gas pipeline networks fail to properly consider these factors, among others.

Gas pipeline utility managers conventionally follow a set of work instructions during analysis and replacement of components in the utility network. The instructions may include performing floating surveys, site inspections, collecting survey results, preparing inspection reports, analyzing survey and inspection reports, and deriving an action plan. Current work instructions may require extensive manual effort by human operators (e.g., technicians, surveyors, etc.), making analysis and replacement of components a costly and time-consuming procedure.

Aspects of the invention generally include obtaining data about component fault histories, data about component faults currently under investigation (one-call ticket data, or fault ticket data), and historical disaster data; grouping the fault data (historical and under investigation) according to location (using GIS data) and severity of fault or likely fault; and creating a set of work instructions based upon the groupings.

In one embodiment, aspects of the invention provide for a system having: at least one computing device adapted to configure a gas pipeline network by performing actions including: obtaining fault data about components in the gas pipeline network, the fault data including: fault history data, fault ticket data, and historical disaster data; determining a replacement priority for at least two of the components in the gas pipeline network based upon the fault data; and generating a set of replacement work instructions for the at least two components based upon the replacement priority.

Further aspects of the invention include providing work instruction map data, including replacement priority data, which may allow an operator or technician to see a prioritized map layout of areas in the gas pipeline network that require attention. For example, in one embodiment, a section of the pipeline network may be identified as requiring attention, based upon a number of leaks or predicted number of leaks occurring (or predicted to occur) within components grouped in that section. The work instruction map data may be color-coded or otherwise include indicators of severity of faults.

As will be appreciated by one skilled in the art, the gas pipeline network configuration system described herein may be embodied as a system(s), method(s) or computer program product(s), e.g., as part of a gas pipeline network configuration system. Accordingly, embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Magik, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments of the present invention are described herein with reference to data flow illustrations and/or block diagrams of methods, apparatus (systems) and computer program products according to embodiments of the invention. It will be understood that each block of the data flow illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

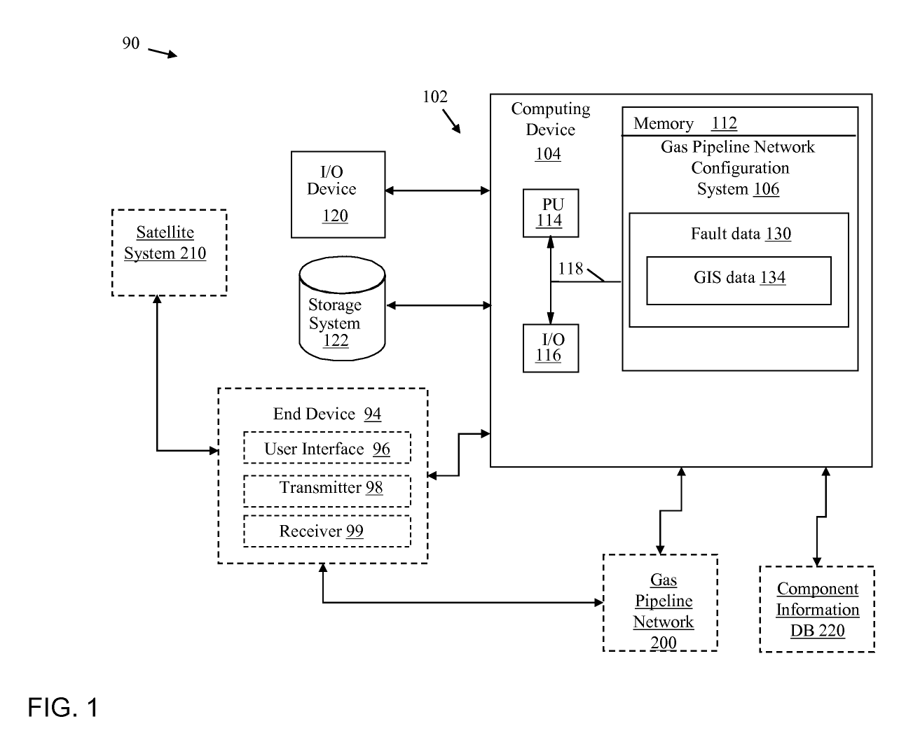

Turning to FIG. 1, an illustrative environment 90 including a gas pipeline network configuration system 106 is shown according to embodiments of the invention. Environment 90 includes a computer infrastructure 102 that can perform the various processes described herein. In particular, computer infrastructure 102 is shown including a computing device 104 that comprises the end device configuration system 106, which enables computing device 104 to configure an end device 94 in the electrical network 200 by performing the process steps of the disclosure.

Computing device 104 is shown including a memory 112, a processor (PU) 114, an input/output (I/O) interface 116, and a bus 118. Further, computing device 104 is shown in communication with an external I/O device/resource 120 and a storage system 122. As is known in the art, in general, processor 114 executes computer program code, such as gas pipeline network configuration system 106, that is stored in memory 112 and/or storage system 122. While executing computer program code, processor 114 can read and/or write data, such as fault data (or, component fault data) 130, which may include GIS data 134, to/from memory 112, storage system 122, and/or I/O interface 116. Bus 118 provides a communications link between each of the components in computing device 104. I/O device 120 can comprise any device that enables a user to interact with computing device 104 or any device that enables computing device 104 to communicate with one or more other computing devices. Input/output devices (including but not limited to keyboards, displays, pointing devices, etc.) can be coupled to the system either directly or through intervening I/O controllers.

In some embodiments, as shown in FIG. 1, environment 90 may optionally include an end device 94 and a gas pipeline network 200 operably connected to the gas pipeline network configuration system 106 through computing device 104 (e.g., via wireless or hard-wired means). In one embodiment, end device 94 may include a transmitter 98 for transmitting data (e.g., GIS data 134) to gas pipeline network configuration system 106, and a receiver 99 for receiving data (e.g., GIS data 134) from, e.g., a satellite system 210. It is understood that gas pipeline network configuration system 106 may further include conventional transmitters and receivers for transmitting and receiving, respectively, data from the end device 94 and/or the gas pipeline network 200. In some embodiments, environment 90 may further include a component information database (DB) 220, which may store fault data 130 e.g., fault history data, pending fault ticket data, component location data (e.g., GIS data 134), and other network configuration data described herein. In some cases, component information DB 220 may be stored within gas pipeline configuration system 106, and in other embodiments, component information DB 220 may be located external to the gas pipeline configuration system 106.

In any event, computing device 104 can comprise any general purpose computing article of manufacture capable of executing computer program code installed by a user (e.g., a personal computer, server, handheld device, etc.). However, it is understood that computing device 104 and gas pipeline network configuration system 106 are only representative of various possible equivalent computing devices that may perform the various process steps of the disclosure. To this extent, in other embodiments, computing device 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 102 is only illustrative of various types of computer infrastructures for implementing the disclosure. For example, in one embodiment, computer infrastructure 102 comprises two or more computing devices (e.g., a server cluster) that communicate over any type of wired and/or wireless communications link, such as a network, a shared memory, or the like, to perform the various process steps of the disclosure. When the communications link comprises a network, the network can comprise any combination of one or more types of networks (e.g., the Internet, a wide area network, a local area network, a virtual private network, etc.). Network adapters may also be coupled to the system to enable the data processing system to become coupled to other data processing systems or remote printers or storage devices through intervening private or public networks. Modems, cable modem and Ethernet cards are just a few of the currently available types of network adapters. Regardless, communications between the computing devices may utilize any combination of various types of transmission techniques.

As previously mentioned and discussed further below, gas pipeline network configuration system 106 has the technical effect of enabling computing infrastructure 102 to perform, among other things, the gas pipeline network configuration functions described herein. It is understood that some of the various components shown in FIG. 1 can be implemented independently, combined, and/or stored in memory for one or more separate computing devices that are included in computer infrastructure 102. Further, it is understood that some of the components and/or functionality may not be implemented, or additional schemas and/or functionality may be included as part of environment 90.

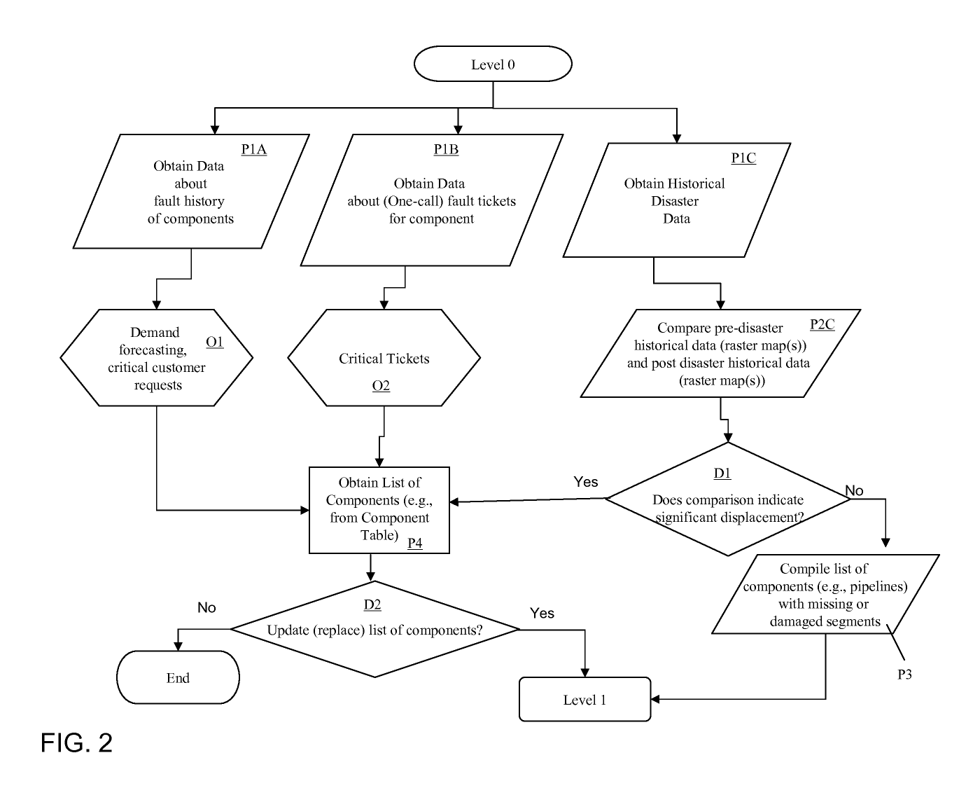

FIG. 2 shows an illustrative flow diagram depicting a method according to embodiments of the invention. It is understood that the method(s) described herein may be performed by at least one computing device adapted to configure a gas pipeline network (e.g., by gas pipeline configuration system 106), or may be performed by at least one computing device (e.g., a general purpose computing device) when a program product is executed thereon. Returning to FIG. 2, as shown, in processes P1A, P1B and P1C, which may be executed at different times or substantially simultaneously, fault data (e.g., fault data 130, FIG. 1) is obtained about components in the gas pipeline network 200. As used herein, components in the gas pipeline network 200 may include pipeline conduits, valves, connectors/joints, etc. It is understood that as described herein, the term “components” or “gas pipeline components” may include any conventional components in a gas pipeline network not specifically recited herein. However, in a specific embodiment, fault data 130 (e.g., data about leaks in components) is obtained and otherwise processed as described herein in connection with potential or actual leaks in gas conduits. That is, in a specific embodiment, fault data 130 may include data about leaks in gas pipelines (and e.g., the pipes, valves, joints, etc. contained therein).

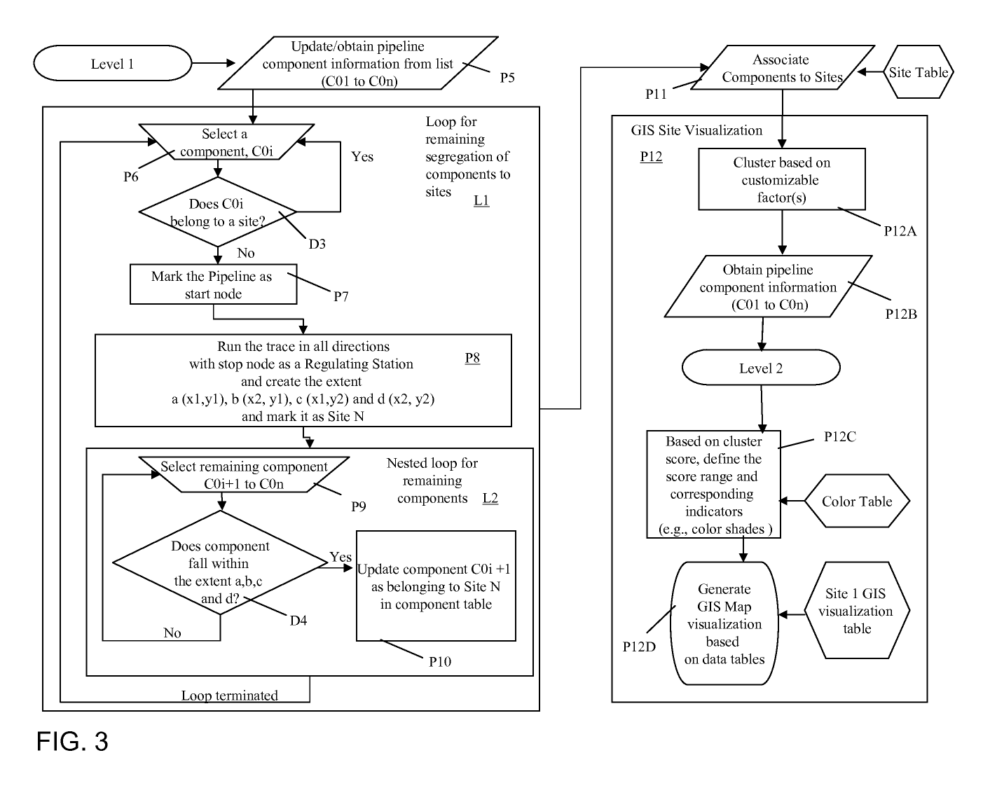

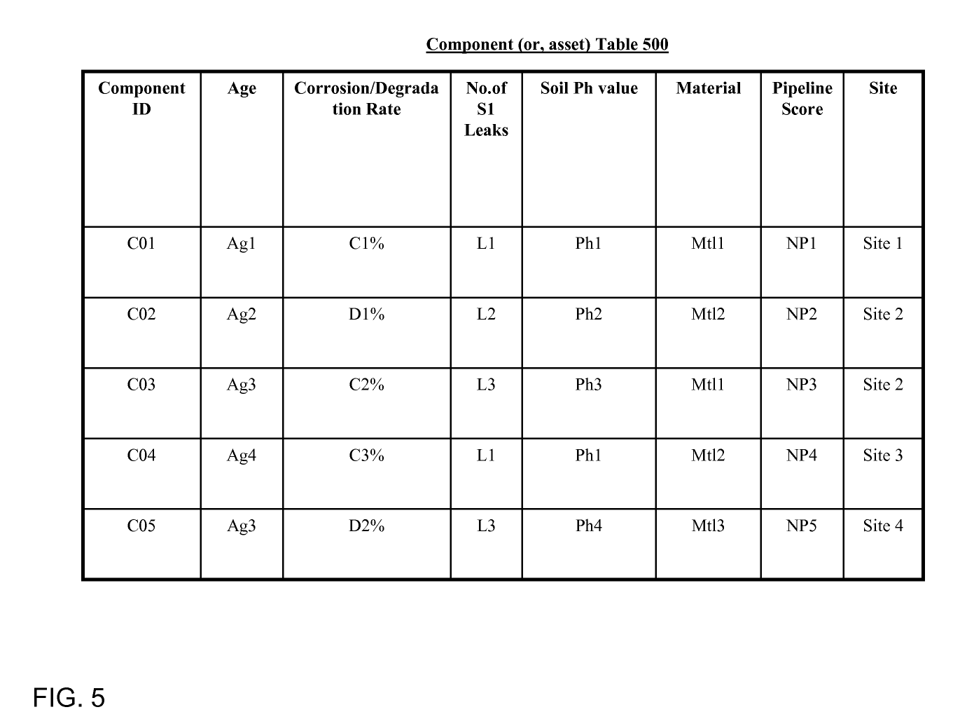

In any case, in process P1A, fault history data is obtained, e.g., from a database such as component information DB 220. Fault history data may include conventional fault history data for components, e.g., data about previous faults experienced by the component (e.g., pipeline leaks). In process P1B, fault ticket data is obtained, e.g., from a database such as component information DB 220. Fault ticket data may include conventional fault ticket data (e.g., pending one-call tickets), which include potential faults that have been indicated by a sensor, a human observer, a captured image, etc. In process P1C, historical disaster data is obtained, e.g., from a database such as component information DB 220. Historical disaster data may include indications of disasters affecting portions of the gas pipeline network, which may include images, maps, coordinate comparisons, topographical changes, etc., which may be taken from satellite images with past and current raster maps. After obtaining the historical disaster data in process P1C, in process P2C, pre-disaster historical data may be compared to post-disaster historical data (e.g., via a raster map comparison) to determine what changes have occurred due to the disaster (e.g., topographical changes, pipeline alignment changes, soil displacement, etc.). In decision D1, following process P2C, it is determined whether a “significant” displacement has occurred. The significance of this displacement may be measured based upon predetermined criteria (e.g., a predetermined amount of displacement) dictated by an entity such as a utility network manager. The actual displacement may be compared with this predetermined displacement criteria to determine whether it is “significant” (e.g., falls outside of the acceptable predetermined criteria). In the case that a significant displacement has not occurred, in process P3, a list of components (e.g., pipelines, joints, conduits, valves, etc.) with missing or damaged segments is compiled. This leads to a further process described with reference to FIG. 3 (Level 1). Returning to processes P1A, and P1B, following the obtaining of fault history data and fault ticket data, data objects (O1, demand forecasting and critical customer complaint data) and (O2, critical ticket data) may be generated based upon the fault history data and fault ticket data, respectively. Data object (O1) may indicate forecast demand for components across the entire pipeline network, or specifically with respect to those components having previous faults. Further, data object (O1) may indicate whether one or more faults are associated with a “critical” customer (e.g., a hospital). Data object (O2) may include data about whether any “critical” fault tickets are pending. Critical tickets may be those pending fault tickets associated with critical customers (e.g., hospitals) on the network. After generating data objects (O1) and (O2), and in the case that a significant displacement is indicated in decision D1 (Yes), in process P4, a list of components in the pipeline network is obtained. In one embodiment, the list of components may be obtained from a component table, such as the example component table 500 shown in FIG. 5. The list of components in the network may include those components associated with data objects (O1) and (O2) and/or other components in the network. After obtaining the list of components, in decision D2, it is determined whether the list of components should be updated based upon at least one of the demand forecast or the critical customer request forecast (O1), critical tickets (O2), or significant displacement in the map data (Yes to decision D1). This decision may further include determining whether one or more component(s) requires replacement based upon the list of components indicating that replacement of at least one component is required. In the case that the list does not require updating (e.g., no significant change to component listings), the process ends.

In the case that the list does require updating, turning to FIG. 3, process P5 includes updating the pipeline component information from the list (e.g., from a list or table as shown in the component table 500 of FIG. 5), and obtaining that updated component information for the purposes of grouping the components in loop L1. Loop L1 includes a process P6 (selecting a component), coupled with decision D3, which, for each component C0i, includes determining whether the selected component C0i belongs to (or is assigned to) a site location. That is, process P6 and decision D3, may include analyzing the component table 500 (FIG. 5) or associated list to determine whether the component has been assigned to a site (a geographic location on the pipeline). In the case that the component has been assigned to a site location (Yes to decision D3), then process P6 and decision D3 are repeated for the next component C0(i+1). In the case that the component has not been assigned to a site location (No to decision D3), then in process P7, the component location on the pipeline is designated as a start node for a subsequent tracing process (P8). Following designation of the component as a start node, in process P8, a trace is run along a length of the pipeline (e.g., along a pipeline main line or a pipeline supply line) to determine whether other components are located along the length of the pipeline, until reaching a regulating station (end node). Upon reaching a regulating station, the components noted during the trace are grouped as a site location (Site N). Following identification of site (Site N), the process may progress to nested loop L2, where in process P9, a remaining component, e.g., C0(i+1) (from component table 500, FIG. 5) is selected, and in decision D4, it is determined whether the remaining component falls within the boundary (or, extent) defined by the trace in P8. If not (No to decision D4), then process P9 is repeated for the next remaining component, e.g., C0(i+2). If so (Yes to decision D4), then in process P10, the component C0(i+1) is updated in the component table (e.g., component table 500, FIG. 5) as belonging to Site N.

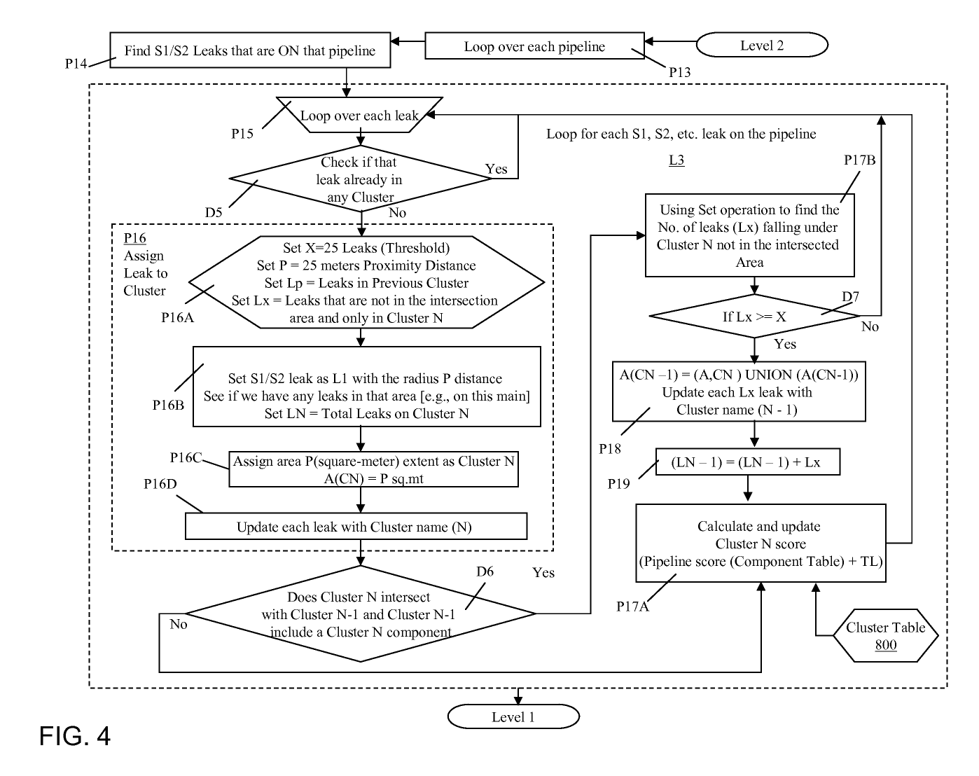

After repeating the loop L1 (and nested loop L2) for remaining components in the gas pipeline network, in process P11, components are associated with Sites (e.g., Site N, Site N+1, Site N+2) in a site table (e.g., a site table 600) that groups components according to their site location. Following process P11, geographical information system (GIS) site visualization may be performed in general process P12. This may include, in process P12A, clustering components based upon customizable factors(s), which may include one or more of: distance between components; length of pipeline segment; age(s) of pipeline segments; proximity and criticality of other utility networks such as electrical networks, including location(s) of underground electrical components such as wiring and cable lines; ground conditions which may be based upon environmental conditions including season and/or temperature, etc. In process P12B, pipeline component information (C01 to C0n) is obtained for the purposes of determining where leaks exist in the pipeline and how they may be attributed to the already determined clusters, or grouped in new clusters (in level 2, FIG. 4).

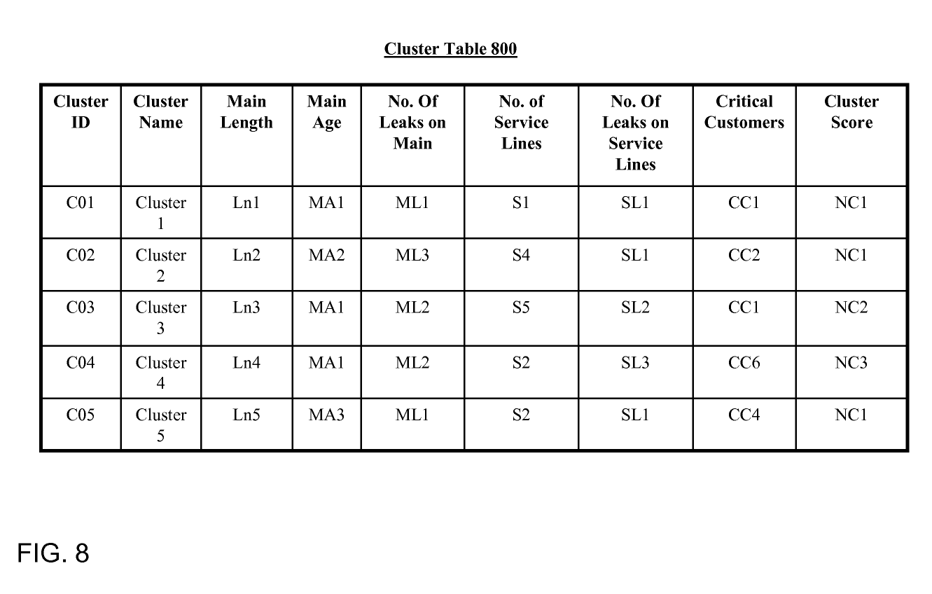

Turning to FIG. 4, in processes P13-P14, for each pipeline, pipeline component leaks are identified (where a severity of leaks in pipeline components is denoted in rank order as S1, S2, S3, etc., as in the example cluster table 800 of FIG. 8) on that pipeline. After locating the pipeline component leaks along the length of pipeline, processes in loop L3 are performed for each pipeline component leak (S1 leak, S2 leak, etc.). For example, in process P15 and decision D5, for each leak (e.g., having a severity level of S1, S2, etc.) in the pipeline component, it is determined whether that leak exists in any established cluster. In the case that the leak exists in the cluster, then a different leak in the pipeline component is chosen and examined (process P15 and decision D5) to determine whether that different leak is located in an already existing cluster. If not (No to decision D5), then in process P16 (including sub-processes P16A-D), the leak is assigned to a cluster.

This process of assigning a component having a leak to a cluster may include, in process P16A: assigning a threshold number of leaks per cluster (e.g., 25 leaks per cluster (set X=25)), setting a proximity cluster distance ((e.g., 25 meters (set P=25 meters), determining a number of leaks in the previously evaluated cluster, such as a proximate or neighboring cluster (set Lp=number of leaks in previous cluster), and determining the number of leaks that are in the intersection of the previous cluster and the newly defined cluster proximity cluster distance (e.g., 25 meters). In process P16B, the leak (e.g., S1 leak or S2 leak) is set as L1, a radius P (e.g., 25 meters) is drawn around that leak location, it is determined whether any leaks are located within the area (e.g., on the same pipeline main line or another pipeline main line), and this total number of leaks within this radius P is set as LN (total number of leaks). Process P16C includes denoting the cluster area as equal to P square meters (e.g., 25 square meters), and process P16D includes updating each leak L with its cluster name N, based upon the component's location in a cluster.

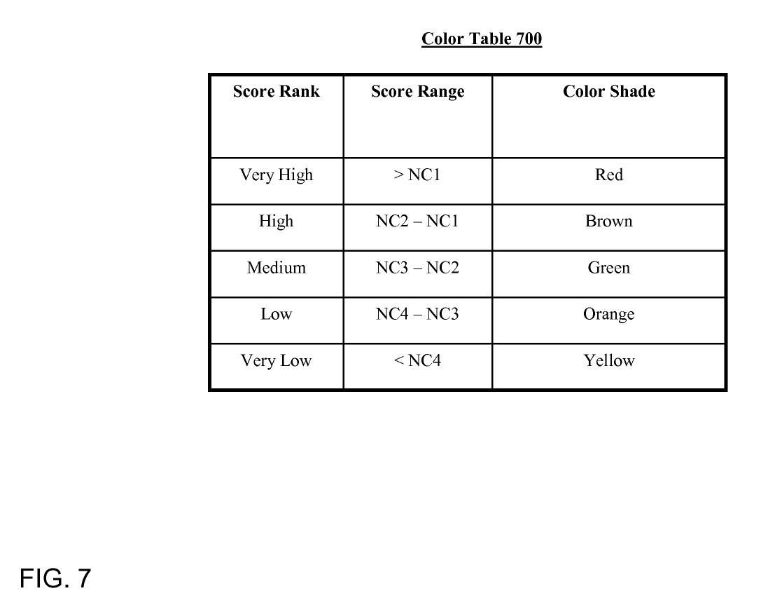

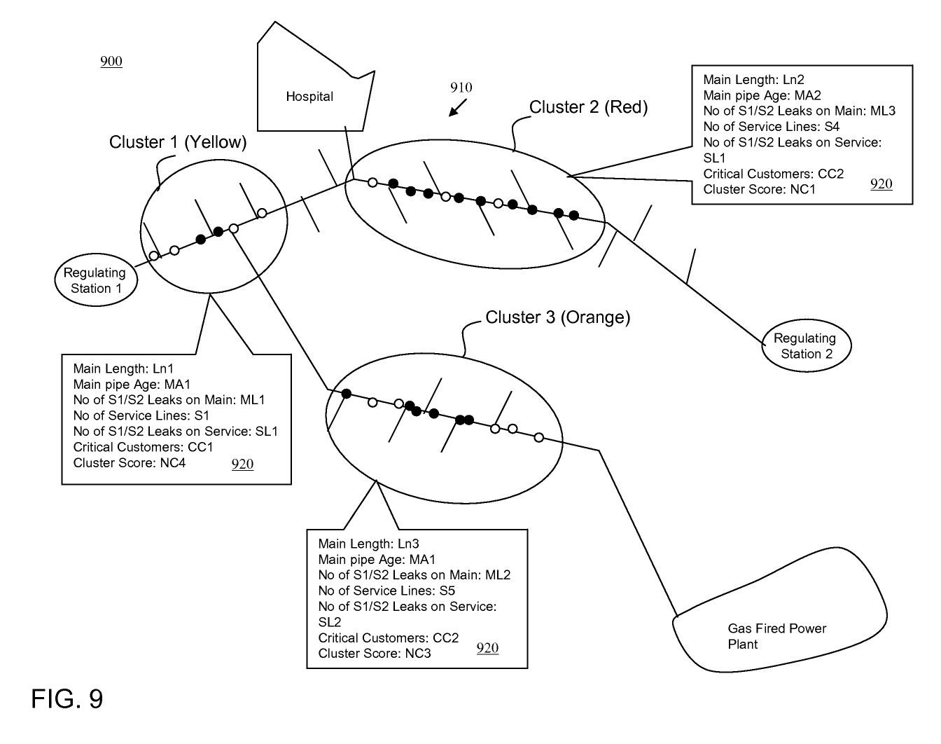

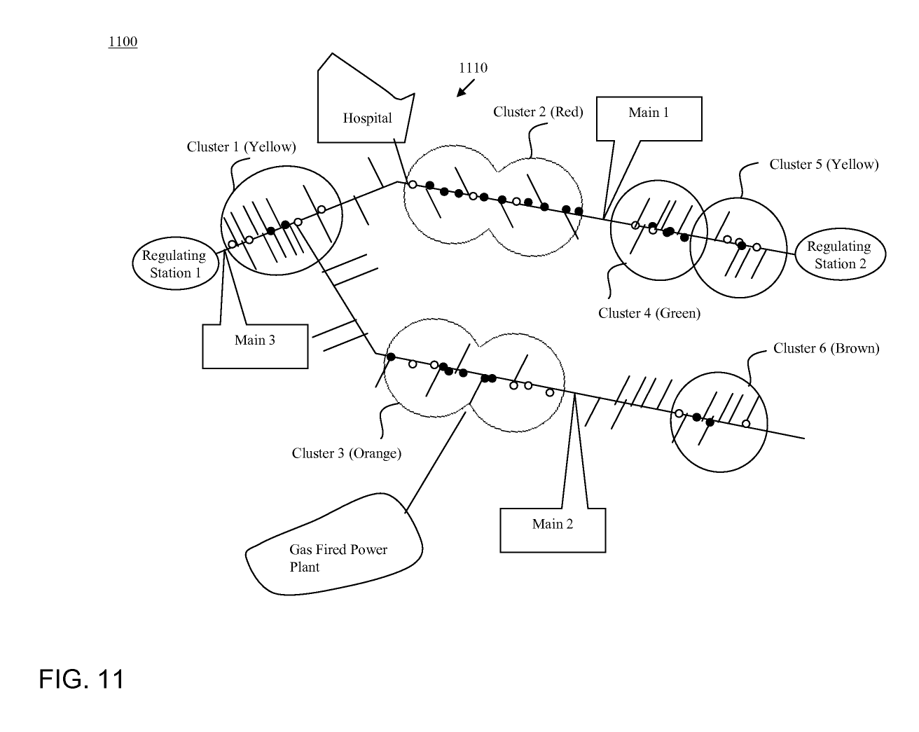

After updating each leak L with its cluster name N (or, in other words, assigning a cluster name N to each leak), in decision D6, it is determined whether cluster C(N) intersects with cluster C(N−1) (a distinct cluster), and if so, whether cluster CN−1 includes a component also assigned to cluster N. In the case that decision D6 is answered in the negative (no cluster intersection or cluster intersection without common component), in process P17A, the cluster score for cluster C(N) is updated, including the pipeline score ((NP1) in component table, FIG. 5), and the number of total leaks (TL). In one embodiment, this process may include updating scores in a score table or score log, e.g., a color table or color log, as shown in the example color table 700 of FIG. 7. For example, scores may be denoted as levels (e.g., Very High, High, Medium, etc.) of replacement priority, based upon attention required, which may be associated with colors or other symbols on a layout or other depiction (e.g., a map such as layout map 900 in FIG. 9 or layout map 1100 in FIG. 11). After calculating and updating the cluster scores (using cluster table 800) in process P17A, then the process may proceed back to Level 1, as depicted in FIG. 3.

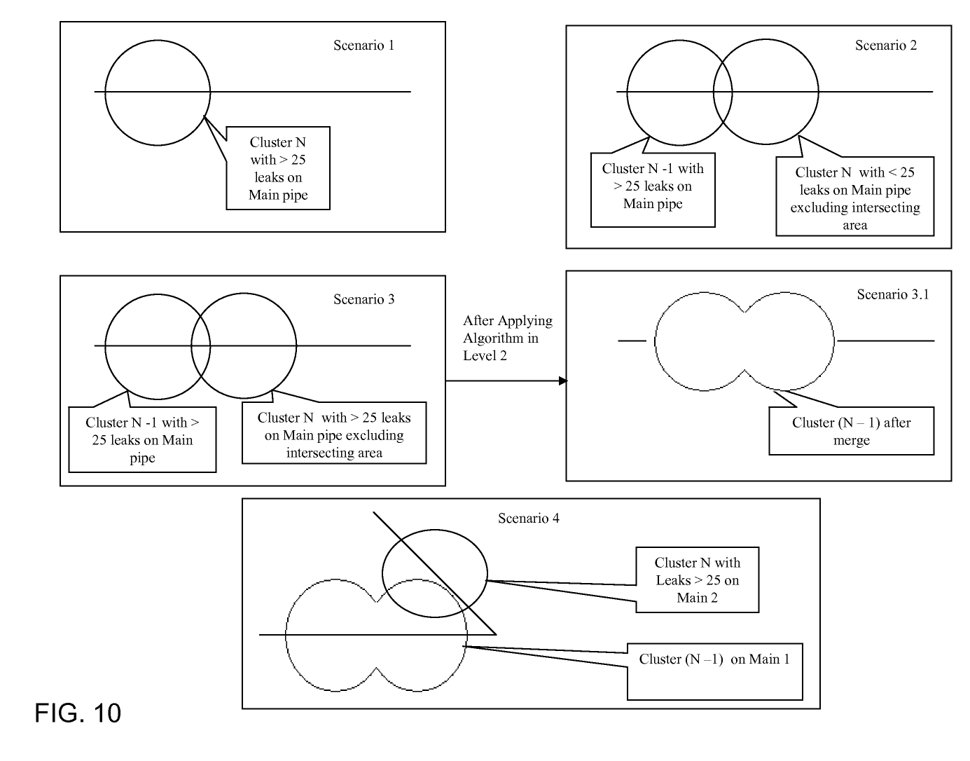

In the case that decision D6 is answered in the affirmative (Yes to cluster intersection and yes to common components), then a series of processes may be performed in order to determine where leaks within overlapping clusters may be assigned. These processes (P17B-P19) will be described with reference to FIG. 4, but also in view of the example clustering scenarios Scenario 1, Scenario 2, Scenario 3, Scenario 3.1 and Scenario 4 of FIG. 10. Returning to FIG. 4, in process P17B, a set operation is performed in order to determine the number of leaks falling within cluster N and not in the intersected area. Following process P17B, in decision D7, the number of leaks (Lx) not in the intersection is compared to the threshold (e.g. 25 in this case) to determine whether the number of leaks equals or exceeds the threshold. In the case that the number of leaks (Lx) not in the intersection does not equal or exceed the threshold X, then the process returns to P15 for another leak (e.g., the next S1, S2, etc. leak). In the case that the number of leaks (Lx) not in the intersection equals or exceeds the threshold X, then in process P18, the overlapping area of cluster N and a neighboring, overlapping cluster C(N−1) are joined, and the leaks within the newly created area is assigned to the cluster CN−1. In process P19, the number of leaks LN−1 in cluster C(N−1) is then updated according to the number of leaks (Lx) not in the intersection. Following process P19, in process P17A, the cluster score for cluster C(N), cluster C(N−1), etc. is updated, including the pipeline score ((NP1) in component table, FIG. 5), and the number of total leaks (TL). After calculating and updating the cluster scores in P17A, then the process may proceed back to Level 1, as depicted in FIG. 3.

Returning to FIG. 3, after grouping leaks into clusters, in process P12C, score ranges are defined based upon the cluster scores, where the ranges allow for distinct levels of replacement priority. In one embodiment, cluster scores may be grouped into several distinct ranges, each range corresponding to a level of replacement priority. This can be seen, for example, in the color table 700, where cluster scores are divided into 5 ranges. In this example, these ranges are associated with color shades and ranks, however, it is possible to divide and denote score ranges in other manners not shown.

Following process P12C, in process P12D, a geographical information system (GIS) map (or other visualization) may be generated based upon the data tables (e.g., component table 500, site table 600, color table 700 and/or cluster table 800). For example, FIG. 9 depicts a work instruction map (or, visualization) 900 showing three distinct clusters along a gas pipeline network 910. These clusters include Cluster 1, Cluster 2 and Cluster 3, each having attributes such as main line lengths, main line ages, main line leaks, service lines, service line leaks, critical customers, and attributed cluster scores. Some or all of these attributes may be displayable on the work instruction map 900, e.g., via a “tooltip” display whereby the attributes for a cluster appear in an actuatable window (e.g., windows 920) in response to actuation by a user or viewer. For example, the windows 920 may be actuated (made visible) in the work instruction map 900 after a user's pointer icon (linked, e.g., to a mouse) is placed over or proximate to the cluster. In some embodiments, all of these attributes will contribute to each cluster score, putting the three clusters into distinct classes (or ranges), each class having a distinct replacement priority. These factors may be combined to indicate fault severity criteria, such that those clusters with, e.g., critical customers and older service lines associated with the critical customers may require more imminent attention than clusters with newer service lines and no critical customers. These factors may be determined from data such as installation date data, inspection date data (contributing to uncertainty of reliability where inspection dates are long past), component environmental data (e.g., soil type, soil history, location above or below ground, etc.), component repair history data, component demographic data, etc.

FIG. 11 depicts a second work instruction map 1100, illustrating the merger of smaller clusters along a gas pipeline network 1110 to form larger clusters (e.g., cluster 2, cluster 5). For example, work instruction map 1100 includes two grouped clusters (cluster 2 and cluster 3) that were formed from sub-clusters. These merged clusters may be formed according to the processes outlined herein, e.g., those shown and described with reference to FIGS. 4 and 10. In some cases, as shown in the work instruction map 1100, overlapping clusters may not require merging, as with cluster 4 and cluster 5. In this case, no faults (e.g., leaks) exist within the intersection of these clusters. Accordingly, their merger is unnecessary. As shown in the work instruction maps 900 and 1100, components experiencing faults (e.g., leaks) are indicated by filled circles along main lines, where components without faults are indicated by hollow (or white) circles along main lines. It is understood that clusters may be colored in the work instruction maps 900 and 1100, as indicated in the color table 700 (FIG. 7), such that Red indicates a very high score, where yellow indicates a very low score. Additionally, multiple clusters may be colored in order of their score to indicate the priority of attention required. Other indicators, e.g., shading, hatching, symbols, etc. may be used to indicate priority.

In any case, aspects of the invention provide for detailed work instructions, which may be displayed in the form of a work instruction map (or, e.g., as text), that denote the replacement priority for components in a gas pipeline network (e.g., gas pipeline network 910, 1110) according to cluster scores or rankings

The data flow diagram and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As discussed herein, various systems and components are described as “obtaining” data (e.g., temperatures, grid frequency, etc.). It is understood that the corresponding data can be obtained using any solution. For example, the corresponding system/component can generate and/or be used to generate the data, retrieve the data from one or more data stores or sensors (e.g., a database), receive the data from another system/component, and/or the like. When the data is not generated by the particular system/component, it is understood that another system/component can be implemented apart from the system/component shown, which generates the data and provides it to the system/component and/or stores the data for access by the system/component.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently, depending upon the act involved. Also, one of ordinary skill in the art will recognize that additional blocks that describe the processing may be added.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A system comprising:
at least one computing device adapted to configure a pipeline network by performing actions comprising:
obtaining fault data about components in the pipeline network, the fault data including: fault history data, fault ticket data, and historical disaster data;
determining a replacement priority for at least two of the components in the pipeline network based upon the fault data; and
generating a set of replacement work instructions for the at least two components based upon the replacement priority.

2. The system of claim 1, wherein the fault data further includes geographical information system (GIS) data about the components in the pipeline network.

3. The system of claim 2, wherein the at least one computing device is further adapted to create a GIS work instruction map based upon the replacement work instructions, the GIS work instruction map including at least one of the following:
color-coded indicators of the replacement priority of at least one of the at least two components; and
actuatable display windows displaying at least one of: the fault data and the replacement work instructions for the at least one of the at least two components.

4. The system of claim 1, wherein the at least one computing device is further adapted to create a GIS work instruction map based upon the replacement work instructions, and wherein the determining of the replacement priority for each of the at least two components includes:
determining whether the component belongs to a site location;
designating the component as a start node in the case that the component does not belong to a site location; and
progressively gathering fault data about neighboring components along the pipeline network until reaching a regulating station, the fault data about the neighboring components including geographical information system (GIS) data about the neighboring components.

5. The system of claim 4, wherein the determining of the replacement priority for each of the at least two components further includes:
determining a grouping threshold based upon the fault data for the components and the neighboring components;
forming distinct clusters including at least one of the components and the neighboring components, the forming based upon the grouping thresholds; and
scoring the distinct clusters based upon fault severity criteria.

6. The system of claim 5, wherein the grouping threshold is based upon a number of component leaks within a physical distance.

7. The system of claim 1, wherein the fault data further includes at least one of installation date data, inspection date data, component environmental data, component repair history data or component demographic data.

8. A program product stored on a computer readable medium, which when executed by at least one computing device, performs the following:
obtains fault data about components in the pipeline network, the fault data including: fault history data, fault ticket data, and historical disaster data;
determines a replacement priority for at least two of the components in the pipeline network based upon the fault data; and
generates a set of replacement work instructions for the at least two components based upon the replacement priority.

9. The program product of claim 8, wherein the fault data further includes geographical information system (GIS) data about the components in the pipeline network.

10. The program product of claim 9, wherein the at least one computing device is further adapted to create a GIS work instruction map based upon the replacement work instructions, the GIS work instruction map including at least one of the following:
color-coded indicators of the replacement priority of at least one of the at least two components; and
actuatable display windows displaying at least one of: the fault data and the replacement work instructions for the at least one of the at least two components.

11. The program product of claim 8, wherein the at least one computing device is further adapted to create a GIS work instruction map based upon the replacement work instructions, and wherein the determining of the replacement priority for each of the at least two components includes:
determining whether the component belongs to a site location;
designating the component as a start node in the case that the component does not belong to a site location; and
progressively gathering fault data about neighboring components along the pipeline network until reaching a regulating station, the fault data about the neighboring components including geographical information system (GIS) data about the neighboring components.

12. The program product of claim 11, wherein the determining of the replacement priority for each of the at least two components further includes:
determining a grouping threshold based upon the fault data for the components and the neighboring components;
forming distinct clusters including at least one of the components and the neighboring components, the forming based upon the grouping thresholds; and
scoring the distinct clusters based upon fault severity criteria.

13. The program product of claim 12, wherein the grouping threshold is based upon a number of component leaks within a physical distance.

14. The program product of claim 8, wherein the fault data further includes at least one of installation date data, inspection date data, component environmental data, component repair history data or component demographic data.

15. A system comprising:
at least one computing device adapted to configure a gas pipeline network by performing actions comprising:
obtaining fault data about components in the gas pipeline network, the fault data including: fault history data, fault ticket data, and historical disaster data;
determining a replacement priority for at least two of the components in the gas pipeline network based upon the fault data; and
generating a set of replacement work instructions for the at least two components based upon the replacement priority; and
a user interface operably connected to the at least one computing device, the user interface for displaying the replacement work instructions.

16. The system of claim 15, wherein the fault data further includes geographical information system (GIS) data about the components in the gas pipeline network.

17. The system of claim 16, wherein the at least one computing device is further adapted to create a GIS work instruction map based upon the replacement work instructions, the GIS work instruction map including at least one of the following:
color-coded indicators of the replacement priority of at least one of the at least two components; and
actuatable display windows displaying at least one of: the fault data and the replacement work instructions for the at least one of the at least two components.

18. The system of claim 15, wherein the at least one computing device is further adapted to create a GIS work instruction map based upon the replacement work instructions, and wherein the determining of the replacement priority for each of the at least two components includes:
determining whether the component belongs to a site location;
designating the component as a start node in the case that the component does not belong to a site location; and
progressively gathering fault data about neighboring components along the gas pipeline network until reaching a regulating station, the fault data about the neighboring components including geographical information system (GIS) data about the neighboring components.

19. The system of claim 18, wherein the determining of the replacement priority for each of the at least two components further includes:
determining a grouping threshold based upon the fault data for the components and the neighboring components;
forming distinct clusters including at least one of the components and the neighboring components, the forming based upon the grouping thresholds; and
scoring the distinct clusters based upon fault severity criteria.

20. The system of claim 19, wherein the grouping threshold is based upon a number of component leaks within a physical distance.
